(19) United States
(12) Patent Application Publication
(10) Pub. No.: US 2010/0102037 A1
(43) Pub. Date: Apr. 29, 2010

(54) MIG- OR MAG-WELDING GUN

(76) Inventor: Erkki Tapio Kettunen, Rauma (FI)

Correspondence Address: KOLISCH HARTWELL, P.C., 200 PACIFIC BUILDING, 520 SW YAMHILL STREET, PORTLAND, OR, 97204, US

(21) Appl. No.: 12/530,410

(22) PCT Filed: Mar. 7, 2008
(86) PCT No.: PCT/FI08/50106

§ 371 Date: Sep. 8, 2009

(30) Foreign Application Priority Data
Mar. 9, 2007 (FI) 20075164

(51) Int. Cl. B23K 9/16

(52) U.S. Cl. 219/74

(57) ABSTRACT

The invention relates to a MIG- or MAG-welding gun, comprising a hand-held grip for supporting, handling and aiming the welding gun during a welding process, the grip including a body member (1). The grip further includes a grip member (2) pivotable relative to the body member (1) and lying alongside the body member over at least part of the same lengthwise extent as the body member. The grip member (2) has its free end pivotable to such a distance from the body member (1) that a hand grasping around the pivotable grip member (2) fits between the body member (1) and the pivotable grip member (2), the body member (1) resting on top of the hand. When the pivotable grip member (2) has its free end is in its position pivoted into the engagement with the body member (1), these two components constitute jointly a handle for the hand to grasp around.

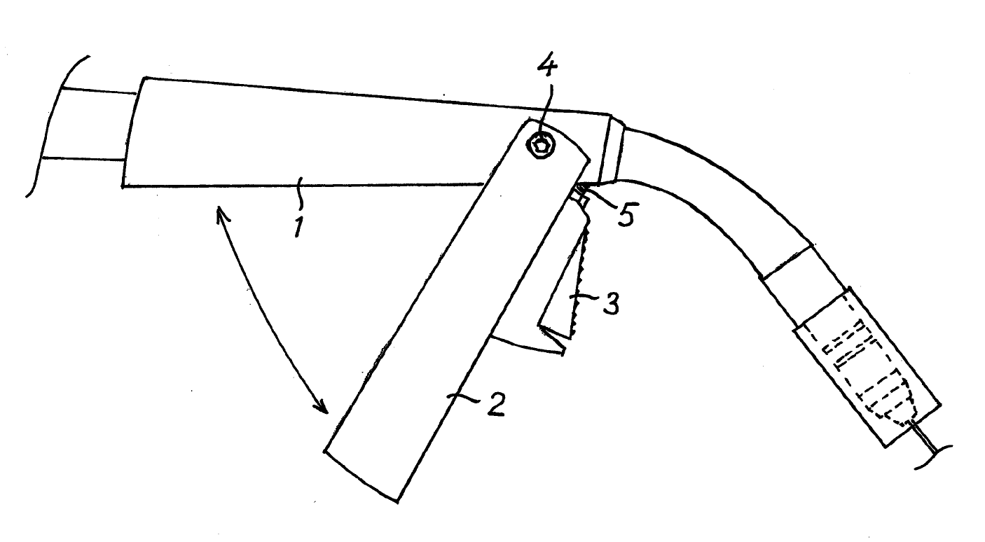

The invention relates to a MIG- or MAG-welding gun, comprising a hand-held handle for supporting, handling and aiming the welding gun during a welding process, the handle including a body member and a grip member pivotable relative to the body member and lying alongside the body member at least partially over the same lengthwise extent as the body member, whereby the grip member has its free end pivotable to such a distance from the body member that a hand grasping around the pivotable grip member fits between the body member and the pivotable grip member, the body member resting on top of the hand.

Patent publications WO 0234450 and U.S. Pat. No. 4,161,643 disclose a pistol type handle of this type, including a pivotable grip. These handles have not become generally popular for the reason of being heavy and only enabling one type of operating mode in which the hand is always under the body. Consequently, the models in general use are those without a handgun grip protruding from the body, but instead the body of a “welding gun” also functions at the same time as a grip or a handle.

In welding guns of this type, the welding wire and shielding gas are passed axially lengthwise of a handle through the handle. The handle has an extension in the form of an arcuate shank, having its end provided with a welding nozzle and a shielding gas dome surrounding the nozzle.

A problem with such welding guns is that, in the process of welding various types of joints, the hand position may be wrong and the hand becomes tired as a result of having to support the welding gun. This makes welders susceptible to neck and shoulder ailments and the arm and palm may develop repetitive stress injuries, such as tendovaginitis.

Patent publication U.S. Pat. No. 6,225,599 discloses a MIG-welding gun, the handle of which comprises two axially successive handle elements, with e.g. a 20° angle therebetween. Even this does not eliminate the problem that, in the case of some welding joints, such as in overhead fillet and horizontal vertical fillet welding processes, the welding gun must nevertheless be supported by a hand in a slightly raised position in which the hand becomes tired.

It is an object of the invention to provide an ergonomic MIG- or MAG-welding grip, which enables changing the position of a hand between various types of welding joint in such a way that, e.g. in overhead fillet welding and vertical horizontal fillet welding processes, the hand can be held at quite a low level in a rest position while the body of a handle rests on top of the hand, whereby the hand does not get tired as easily as in the case of currently available welding guns.

This object is accomplished by the invention on the basis of the characterizing features presented in the appended claim 1. Preferred embodiments of the invention are presented in the dependent claims.

One exemplary embodiment of the invention will now be described more closely with reference to the accompanying drawing, which shows a MIG- or MAG-welding gun of the invention in a side view.

In the illustrated exemplary embodiment, the welding gun comprises a body member 1 and a grip member 2 pivotable relative thereto and lying alongside the body member over at least part of the same longitudinal extent as the body member. The grip member 2 has its free end pivotable to such a distance from the body member 1 that a hand grasping around the pivotable grip member 2 fits between the body member 1 and the pivotable grip member 2, the body member 1 resting on top of the hand in this working position. When the pivotable grip member 2 has its free end in its position pivoted into the engagement with the body member 1, the body member 1 and the pivotable grip member 2 constitute jointly a handle for the hand to grasp around. Depending on whether a hand is used to grasp an opened-up grip member 2 or a handle constituted jointly by the closed-in grip member 2 and the body member 1, it will be possible to choose the best possible position for the hand in the process of welding different types of joints.

An actuating trigger 3 is included in the pivotable grip member 2 along its side facing away from the body member 1, in the proximity of that end of the pivotable grip member 2 which is provided with a pivot link 4. Thus, in the illustrated embodiment, the grip member 2 connects directly by way of the pivot link 4 to that end of the body member 1 which is closer to the nozzle end of the welding gun. A single pivot link 4 is the simplest and most cost-efficient solution. In practice, it does not increase the price of a welding gun at all. Still, instead of a simple pivot link 4, it is of course possible to employ other mechanisms as well, such as a combination of a pivot link and a slide, by means of which the components 1 and 2 can be brought appropriately apart from each other for a hand to fit therebetween while the hand is in a grasp around the grip member 2.

The pivotable grip member 2 further includes a limiter 5 for its pivoting angle, by means of which the pivoting angle is adjustable. Housed in the grip member 2 can be for example a thumbwheel for this adjustment. The pivotable grip member 2 has its pivoting angle relative to the body member's 1 longitudinal axis within the range of 30-75° , preferably 40-60° . Of course, the angle can be smaller if the pivoting motion is accompanied by said slide mechanism.

The pivotable grip member 2 is preferably in the shape of a trough, whereby the trough can be dimensioned to fit over the body member in a way that the body member 1 is at least partially accommodated within the trough.

In the illustrated case, the body member 1 and pivotable grip member 2 constitute jointly a V-fork as the pivotable grip member 2 is in its position turned away from the body member 1.

1. A MIG- or MAG-welding gun, comprising a hand-held handle for supporting, handling and aiming the welding gun during a welding process, the handle including a body member and a grip member pivotable relative to the body member and lying alongside the body member over at least part of the same lengthwise extent as the body member, whereby the grip member has its free end pivotable to such a distance from the body member that a hand grasping around the pivotable grip member fits between the body member and the pivotable grip member, the body member resting on top of the hand, characterized in that the pivotable grip member is in the shape of a trough, the trough being dimensioned to fit over the body member in a way that the body member is at least partially accommodated within the trough, and that, when the pivotable grip member has its free end in its position pivoted into the engagement with the body member, these two components constitute jointly a handle for the hand to grasp around.

2. The welding gun as set forth in claim 1, characterized in that an actuation trigger is included in the pivotable grip member on its the side facing away from the body member, in the proximity of that end of the grip member which is provided with a pivot link.

3. The welding gun as set forth in claim 1 or 2, characterized in that the pivotable grip member includes a limiter for its pivoting angle, by means of which the pivoting angle is adjustable.

4. The welding gun as set forth in claim 1 or claim 2, characterized in that the pivotable grip member has its pivoting angle relative to the body member's longitudinal axis within the range of 30-75°.

5. The welding gun as set forth in claim 1 or 2, characterized in that the handle has its body member and pivotable grip member jointly constituting a V-fork as the pivotable grip member is in its position pivoted away from the body member.

6. The welding gun as set forth in claim 4, characterized in that the pivotable grip member has its pivoting angle relative to the body member's longitudinal axis within the range of 40-60° .
